(19) United States
(12) Patent Application Publication
(10) Pub. No.: US 2002/0087568 A1
(43) Pub. Date: Jul. 4, 2002

(54) Method and software for providing context sensitive database query parameters

(76) Inventors: Gerald LeDonne, Freehold, NJ (US); Nicolas Vu-Huu, Tokyo (JP); Antonio Miguel Pollan, Staten Island, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 09/975,554

(22) Filed: Oct. 10, 2001

Related U.S. Application Data
(60) Provisional application No. 60/238,152, filed on Oct. 6, 2000.

(51) Int. Cl. G06F 17/00

(52) U.S. Cl. 707/100

(57) ABSTRACT

The present invention provides a method and software for providing context sensitive query parameters. The method and software determines a first location of a user within an information system. A data structure is queried, the data structure storing one or more query parameters each associated with a location in the information system, with a query comprising a first identifier indicating the first location of the user within the information system. The query is operative to return one or more first query parameters associated with the first identifier. The first query parameters are transmitted to the user.

Applicant(s) hereby claims the benefit of provisional patent application serial No. 60/238,152, titled “METHOD AND SOFTWARE FOR CONTEXT SENSITIVE DATABASE QUERY PARAMETERS,” filed on Oct. 10, 2000, attorney docket no. 3271/93PROV. The application is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to systems and methods for querying information sources. More particularly, the present invention relates to a system and method for providing users with pre-selected parameters that can be dynamically assembled into a database query. Depending on the context, or user's location within the system, different search and/or query parameters are provided.

A standard for formulating queries to be executed by a relational database is the Structured Query Language (SQL). Using this language, a database or software developer working with a relational database formulates a query by first providing the value of a column or columns from which to pull data for the result set. The query must also specify the name of a table or tables in a database that the query will be run in. The data contained in these tables will be the set of data that the query's result set will be drawn from. Optionally, the query contains a criteria or criterion, with associated values, to limit the scope of a result set to particular values. For example, if a developer was constructing a piece of software that required the first and last name of all system users who live in the “555” area code, the query would be formulated as follows:

Select First-Name, Last Name

From Users

Where Area Code=“555”

As queries become more complex, sophisticated knowledge is required to properly formulate queries. Moreover, many users do not have the time and skill to master the use of SQL for even simple queries.

In response to this problem, many web-based systems employ a series of drop down menus and text input boxes that allow users to graphically formulate information retrieval queries. The user selects one of several criteria from a drop down menu and provides one or more values for the selected criteria by entering it into a text box or selecting it from a further drop down menu. After the query is formulated, a control is provided to execute it in the database. For example, many web sites provide functionality that allows a user to search the contents of their sites. These sites typically provide a drop down menu containing different areas of the site to conduct the search on, along with a text entry box to provide a criterion to search for.

This approach, however, has significant shortcomings. One limitation is that the contents of the drop down menus provided do not update themselves when a user navigates to a new location within the site. In other words, the various criteria available for the user to use to formulate his or her query do not change to reflect the user's new context within the system. Moreover, the criteria are often hard-coded with the system, making update a painstaking chore.

There is thus a need for a method and software to provide users with graphic controls to formulate search queries where the values supplied by the controls change dynamically to reflect the user's context within a web site.

### BRIEF SUMMARY OF THE INVENTION

The present invention provides a method and software for dynamically updating the search criteria available to a user depending of the context of the user within an information system. The present invention also provides a modular way of organizing information such that new content areas can easily be added.

The system and method of the present invention organizes a body of information into a hierarchical structure. The structure is divided into one or more high level subsets of information, referred to as silos. Each high level subset of the hierarchy is further organized into one or more categories and sub-categories, each containing a subset of the information contained in the high level subset it is a part of. As a user navigates through the hierarchical structure, the state and location of the user is stored in a data structure accessible by the system.

The system further comprises an integrated search bar. The search bar is comprised of a number of GUI selection controls and text boxes whose content changes depending on the location of the user. When viewing high level subsets of the hierarchy, but before navigating to a particular category within any of the high level subsets, certain values will populate the GUI controls that allow the user to select the scope and criteria of the search. As the user navigates to categories and sub-categories within one of the high level subsets, the values presented by the controls are dynamically updated to present only values that are relevant to the particular area of the hierarchical structure that the user is located in.

Simple searches of an information repository are also provided for. In these situations, only one pull-down menu and text entry box, or similar GUI controls, are provided. The value selected from the GUI control defines the criteria for the simple search. A text entry control, which alternately could be any GUI component that allows the user to free-form text values, defines the value for the criteria.

The system presents a fully modular architecture that allows the system to easily support new high level subsets of information, e.g., silos. Because the silos are contained in a database, designers simply create new silos with associated categories and sub-categories, e.g., hierarchical subsets of information, that are “plugged into” the database. Likewise search scope and criteria structures are also stored in hierarchical structures within the database and can be added to the existing structure to present search values for the newly added data to the user.

The present invention provides software that executes a method for providing context sensitive query parameters for graphically formulating a query for processing by a data structure, e.g., database and database management system. The method determines a first location of a user within an information system and querying the data structure containing one or more query parameters indexed by location. The query provided to the data structure comprises a first identifier indicating the first location of the user within the information system. The data structure returns one or more query parameters associated with the first identifier and displays the query parameters on a display device for selection by the user. The data structure may be comprised of a database, including relational, object-oriented, and other types of databases.

A second location of the user within the information system may also be determined, which is used for querying the data structure by providing a second identifier indicating the second location of the user within the information system. The data structure returns one or more query parameters associated with the second identifier and displays the query parameters on the display device for selection by the user. The data structure may also be queried by providing the first or second identifier indicating the first or second location of the user within the information system and returning one or more query labels associated with the first or second identifier. Based on the provided first or second identifier, the method executed by the software determines the query parameters that the query label is associated with. The query label may be displayed on the display device in proximity to the associated query parameter.

The method may display the query parameters using GUI selection controls, e.g., a drop down list GUI control. The data structure is queried by providing the first or second identifier indicating the first or second location of the user within the information system. This generates one or more GUI controls; the number of GUI controls generated being determined by the first or second identifier indicating the first or second location of the user within the information system. The query parameters are displayed using the generated GUI controls.

A query is graphically constructed by selecting the desired query parameters from the GUI controls displayed on the display device. The data structure is queried using the query constructed in the selecting step and a result set is returned comprising data stored in the data structure that falls within the scope defined by the query.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system according to one embodiment of the present invention;

FIG. 2 is a screen drawing of an information system structured according to one embodiment of the present invention;

FIG. 3 is anther screen drawing of an information system structured according to one embodiment of the present invention;

FIG. 4 presents two relational database tables containing site structure information according to one embodiment of the present invention.

FIG. 5 is a flow diagram outlining the process of tracking a user's location according to one embodiment of the present invention;

FIG. 6 is a flow diagram outlining the process of populating the contents of search controls based on a user's location according to one embodiment of the present invention; and

FIG. 7 is a continuation of the flow diagram outlining the process of populating the contents of search controls based on a user's location according to one embodiment of the present invention.

### DETAILED DESCRIPTION OF THE PREFERRED EMBODIMENTS

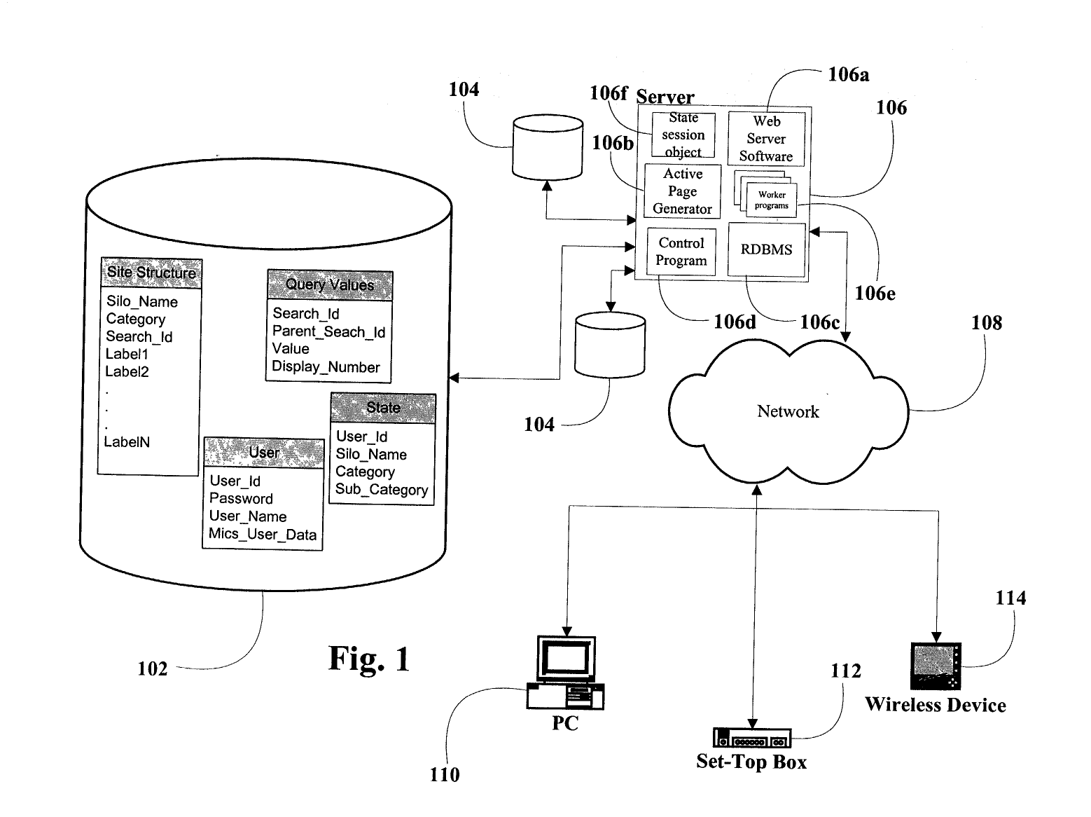

FIG. 1 is a block diagram presenting the hardware and software components that comprise the system. A database 102 is structured to hold information regarding the hierarchical structure of an information system. Information regarding the hierarchical may include, but is 10 not limited to, the silo name, the category name, the search id value for the category, and labels that are to be displayed on the search bar by the system when a user navigates into a particular category. The database also includes information regarding query scope values and associated criteria values. This information includes, among other data, a search id, a parent search id to facilitate a hierarchical structure of values, the value itself, and a display number to instruct the system as to where the value should be displayed on the screen.

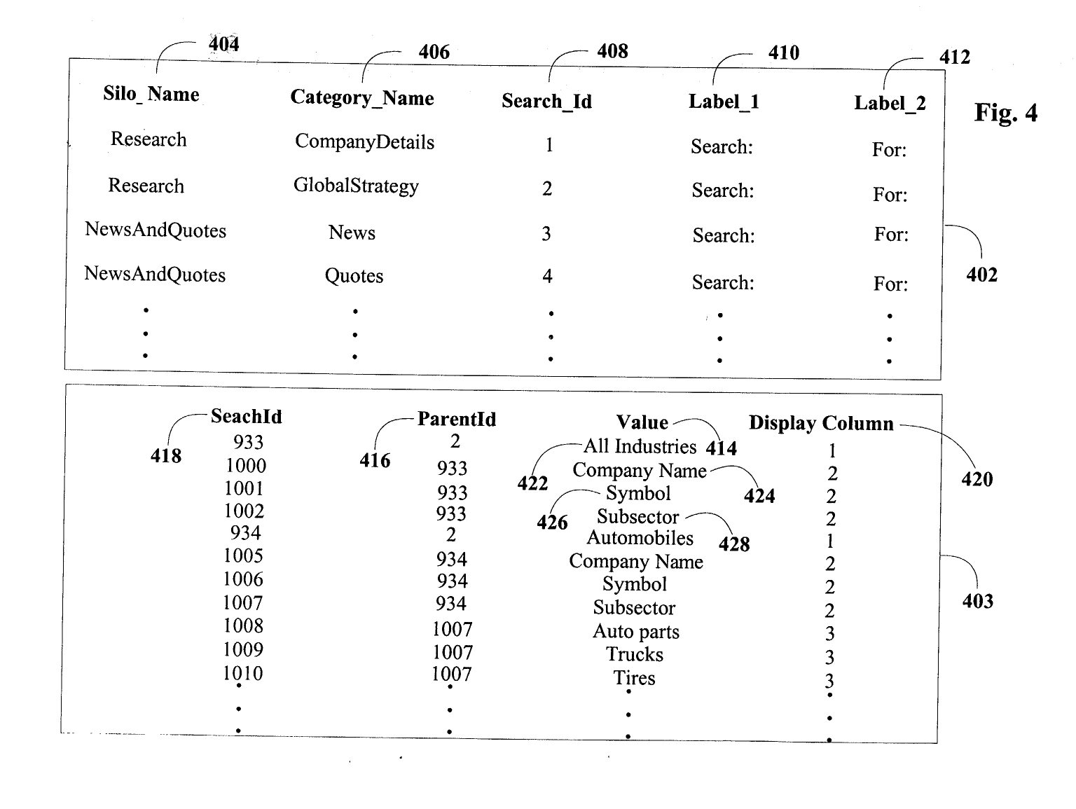

As one skilled in the art will recognize, the database 102 may contain one or more tables and have any desired structure that accurately represents the hierarchical organization of the information system. One embodiment of the invention is a database structured as a relational database, as is shown by two exemplary tables in FIG. 4. A second embodiment involves utilizing an object-oriented database management system whereby each silo or content area is modeled as an object and the database is structured so as to reveal the hierarchical relationship between the objects.

A server computer 106 is electrically coupled to the database and contains web server software 106a, an active page generator 106b, Database Management System software 106c, a control program 106d, one or more worker programs 106e, and a session object 106f. Alternatively, the database 102 can be located on the server computer 106. The control program 106d receives search requests, e.g., SQL queries, and passes them to the appropriate worker program or programs 106e to query a data repository 104. The active page generator 106b receives requests for pages and generates the appropriate pages by issuing requests to the RDBMS 106c to determine a user's state. Alternatively, state information is maintained within the session object 106f that contains the user's location within the system as well as entitlement and state information. Based on a user's entitlements and location within the information system, an appropriate page is created by the active page generator 106b. An exemplary active page generator 106b would be the Active Server Page software developed by MICROSOFT™ or Java Server Pages, Java Servelets, and Enterprise Java Bean (EJB) technologies developed by SUN MICROSYSTEMS™.

Web server software 106a serves the requested pages that can include content from any number of content sources 104. Web server software 106a is comprised of components such as HTTP web servers, e.g., for transmission of generated web pages to an end user, and application servers for execution of business logic functions. The web server 106 is electrically coupled to a computer network 108 and is in communication with a number of clients connected to the network including, but not limited to, personal computers 110, set-top boxes 112 or wireless devices 114. These clients 110, 112, 114 issue page requests to the server 106, which are processed and returned across the network 108.

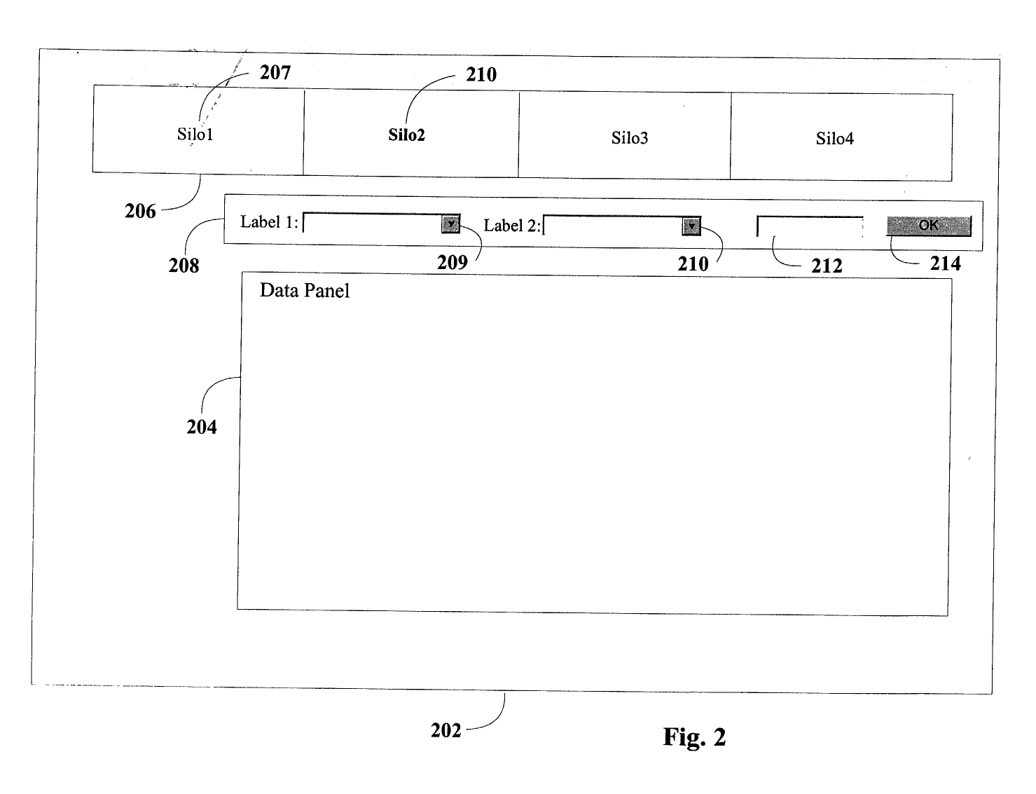

FIG. 2 presents a screen drawing showing the configuration of graphical controls of an information system according to one embodiment of the present invention. Running along the top side of the screen 202 is a navigation bar presenting a plurality of “silos” 206. The contents of the silo bar 206 represent high level subsets of the hierarchical structure of the information system. Each individual silo 210 represents a high-level subset of the total information contained in the information system. For example, an information system dedicated to financial news and information could be divided into silos representing news and quotes, research, capital markets, a detailed corporate view, and other financial information.

A data panel 204 occupies the majority of the screen. When a user first accesses the system, the data panel 204 will present information germane to all silos. Likewise, when a user navigates such that no particular silo is selected, the data panel 204 will also present information germane to all silos. Sitting between the silos 206 and data panel 204 is the search bar 208. The search bar consists of a combination of pop-up menus 209, 210 and a text entry box 212 that allow the user to formulate a query to be processed by the system's database management software. The search bar further comprises a graphical button 214 (labeled “go” in the figure) that, when selected, instructs the control program to have the database management software execute the query formulated by the user through the manipulation of the GUI controls 209, 210, 212, 214 that comprise the search bar 208. Alternatively, the GUI controls 209, 210, 212, 24 can be substituted with any graphical control that allows the user to select a value from a plurality of values presented.

As will be further explained herein, the graphical controls present query criteria and values that are relevant to the silo where the user is currently located. As the user navigates between silos by selecting silo controls presented in the silo bar 206, the values presented by the graphical control are relevant to the user's location within the information system. GUI selection controls will be dynamically arranged, e.g., added and removed, as is appropriate based on the navigational behavior of the user or value selected in the GUI selection controls that comprise the search bar. Furthermore, labels associated with each of the GUI selection controls dynamically change to reflect choices that are relevant to the user's current context, e.g., depending on the silo, category, or sub-category where the user is currently location within the information system. When at the top level of the hierarchy, e.g., the user has not navigated to any silo or is at the top level of any given silo, the search bar will present criteria and values that are applicable to all categories within the given silo.

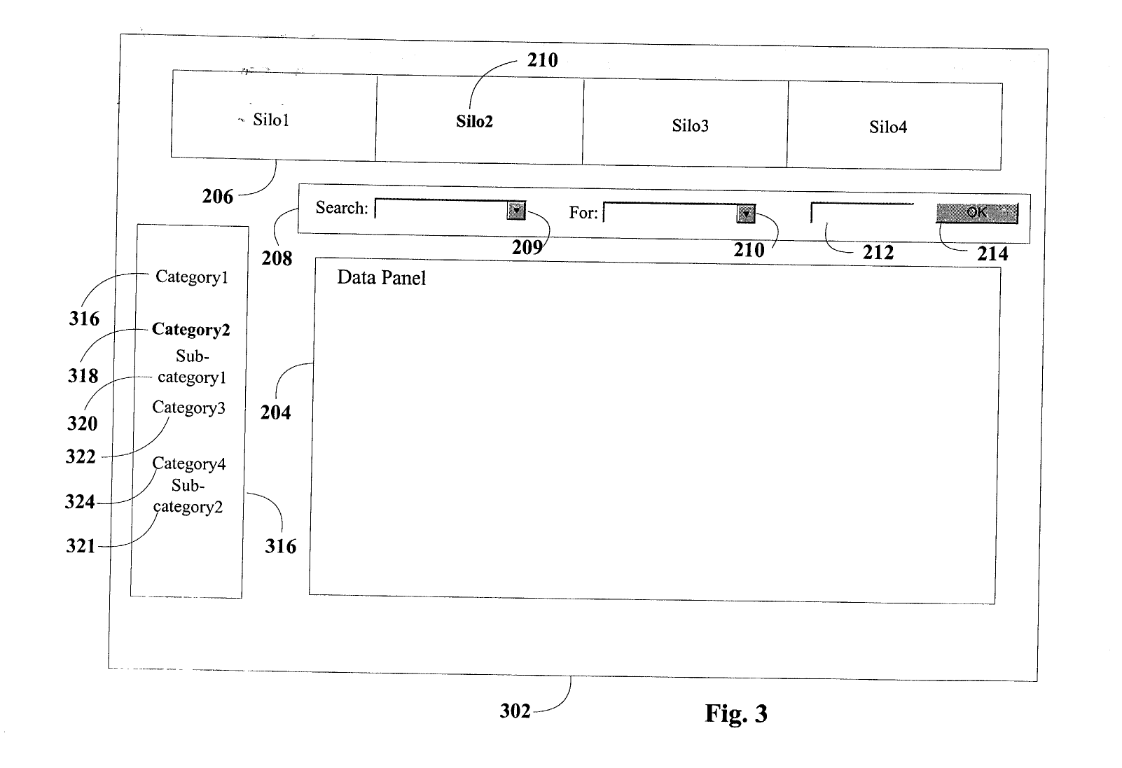

FIG. 3 presents the graphical controls of the information system after the user has selected one of the silos. The “category” navigation bar is introduced, which presents sub-levels of the hierarchy of the selected silo. As previously explained, the site is organized into several top-level categories of a hierarchical structure, also referred to as silos. The hierarchy within each silo is further organized into categories and sub-categories. When a user selects a particular silo 210, a category navigation bar will be presented 316. The contents of the navigation bar are retrieved from the database 102, which contains a table or other data structure arranged to represent the hierarchical relationship between silos and their categories 317, 318, 322, 324 and sub-categories 320, 321. When a user selects a particular category or sub-category, the system database will be queried to populate the graphical controls with values that are relevant to the category 316, 318, 322, 324 or sub-category 320, 321 selected, as defined by the hierarchical structure of the data in the system database.

Controls, 209, 210, 212, present query parameters to the user. As was the case with navigating between silos, the query parameters and controls, as well as GUI control labels, made available through the search bar will change to provide information or parameters that are relevant to the category or subcategory selected by the user. Optionally, GUI controls stay in the same screen location for ease of reference and navigation.

Turning to FIG. 4, two relational database tables are presented. Table 402 presents the structure of the database according to one embodiment of the present invention. Each row in the table represents a silo, or top level of the hierarchy, and its associated categories. The first field of the table contains the value of a silo 404, which represents a top-level grouping of related information categories. The next field contains the name of the category 406, which is followed by a unique identification number through which the category can be referenced 408. The remainder of the table contains label values that are used by the system to label the GUI controls that comprise the search bar. For example, referring to FIG. 3, the labels “Label 1” 209 and “Label 2” 210 are retrieved from fields comprising this table. Each category in table 402 has one or more scope and criteria values associated with it.

The scope and criteria table 403 is structured to hold the search id of the record 418, the parent id of the record's parent 416, and a value 414. An additional field, display column, is provided to instruct the system as to which GUI selection component to display the data in. The manner in which the data is stored creates a hierarchical structure of search scope and associated criterion values.

As can be seen from table 403, the scope and criteria values are structured such that one or more scope values 422 are tied to the category, e.g., the scope of the search. Each scope value, in turn, is associated with one or more criteria values, 424, 426, 428, thereby creating a hierarchical structure. Furthermore, each criteria can be associated with additional values that are displayed in additional GUI controls dynamically added to the search bar. For example, the criteria “subsector”, search id 1007, is a child of “automobiles”, search id 934, and contains additional child values organized beneath it, 1008, 1009, and 1010. When the value “subsector” is selected in the GUI control, its child categories 1007, 1008, 1009, 1010 are loaded into a new GUI selection control that is dynamically added to the search bar. As content areas are added to the system, new scope/criteria values can simply be plugged into the database tables 402, 403 to support searching of the content.

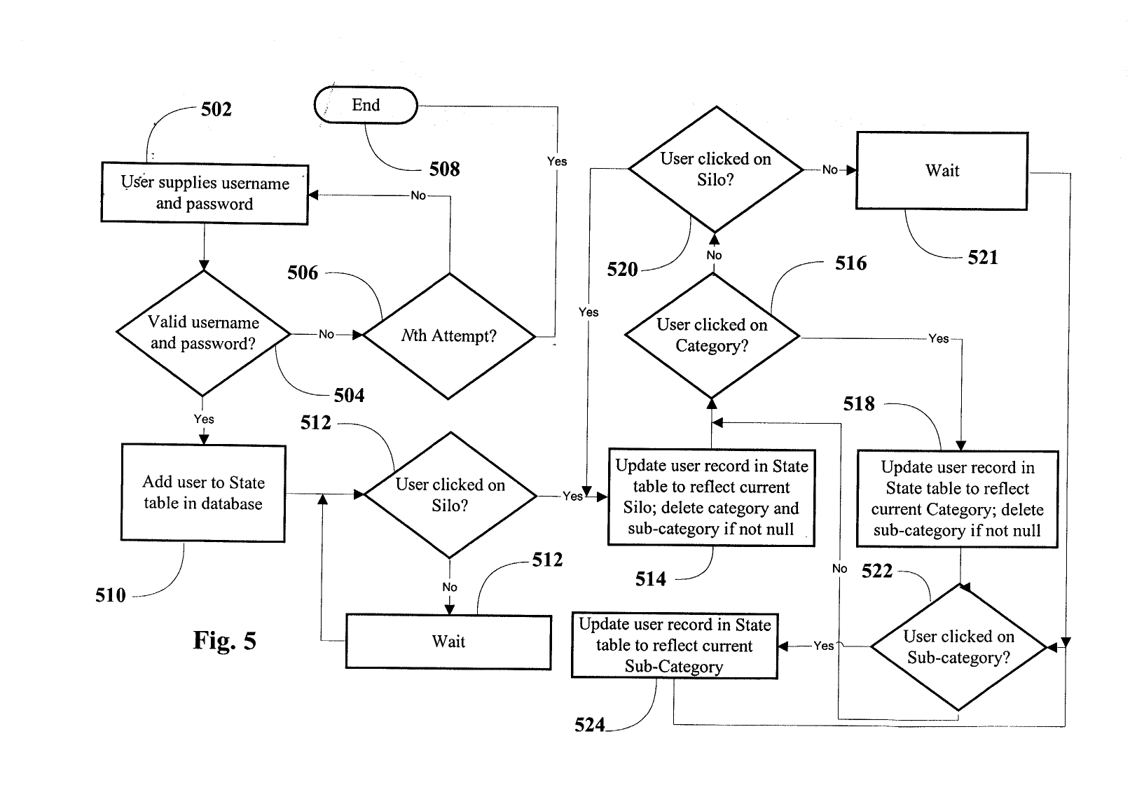

FIG. 5 is a flow diagram presenting a method for tracking the location of a user within the information system. One method of storing the state of a user involves creating a session object within memory on a per user basis, e.g., one object instantiated on the server for each user. The session object is a data structure created to represent specific end-user attributes that are generated as the user interacts with the system, e.g., the user's location with the information system, username, password, entitlement information retrieved from a database, etc. One use of the session object is to determine a user's location within the information system at any point in time. The object-oriented state tracking architecture can be implement using any number of technologies such as Sun Microsystems's Enterprise Java Beans (EJB) or Microsoft's Component Object Model (COM). Alternatively, any changes or interactions performed by the user on the system are written to a state table in a relational database that can be referenced by the system to determine the user's current state. While embodiments presented herein involves using object-oriented programming techniques or relational database systems to determine the location of a user, one skilled in the art will recognize that any number of technologies can be used to implement the method, such as, a file system, flat-file database, pointers, etc.

When a user initially accesses the system, they are prompted for a username and password, step 502. The system will perform a check on the database to determine if the data supplied is valid, step 504. If the data is not valid, a check is performed to determine if the user has exceeded a threshold number of login attempts, step 506. Where the number of login attempts has exceeded the limit set by the system, step 506, the user will be denied access and the routine ends, step 508. If the number of login attempts has not been exceeded, the user will again be prompted for a valid username and password, step 502. Where the data provided is valid, step 504, the user will be logged into the system and an entry will be added to the state-tracking table in the database, step 510. Alternatively, a session tracking object is instantiated at the server for each user upon login, step 510, and updated appropriately. According to some embodiments, the session object is transmitted to the client for storage and accessed by the server as necessary.

After the user is logged in and the system has begun tracking his or her state, the system will determine if the user has selected a particular silo to navigate to, step 512. If the user has not performed any action, the system will wait for a user action, step 513. When the user selects a silo 512, the system will update the user's entry in the state table to reflect the current silo, step 514. Since the user is at the top level of a silo, e.g., has not selected any category or sub-category, the category and sub-category fields will be set to null if they are not already, e.g., the user is navigating to a new silo and was previously in a category or sub-category. The system will determine if the user has selected a category from within the current silo, step 516. If the user has not selected a category, the system will determine if the user selected a silo different from the current silo, step 520. Where a new silo has been navigated to, the system will update the user's record in the state table and delete any category and sub-category data, step 514. If the user has selected neither a category nor a silo, the system will wait for user input, step 521.

When the user selects a category from within the current silo, step 516, the system will update the user's record in the state table to reflect the current category and delete and sub-category information if it is not set to null, step 518. The system will then determine if the user has selected a sub-category from within the current category, step 522. If the user has selected a sub-category, the system will update the user's record in the state table to reflect the current subcategory, step 524. If the user has not selected a sub-category from within the current category, step 522, the system will determine if the user has selected a different category from within the current silo, step 516, or selected a different silo, step 520, and will act appropriately. Where neither case is true, the system will wait for user interaction, step 521.

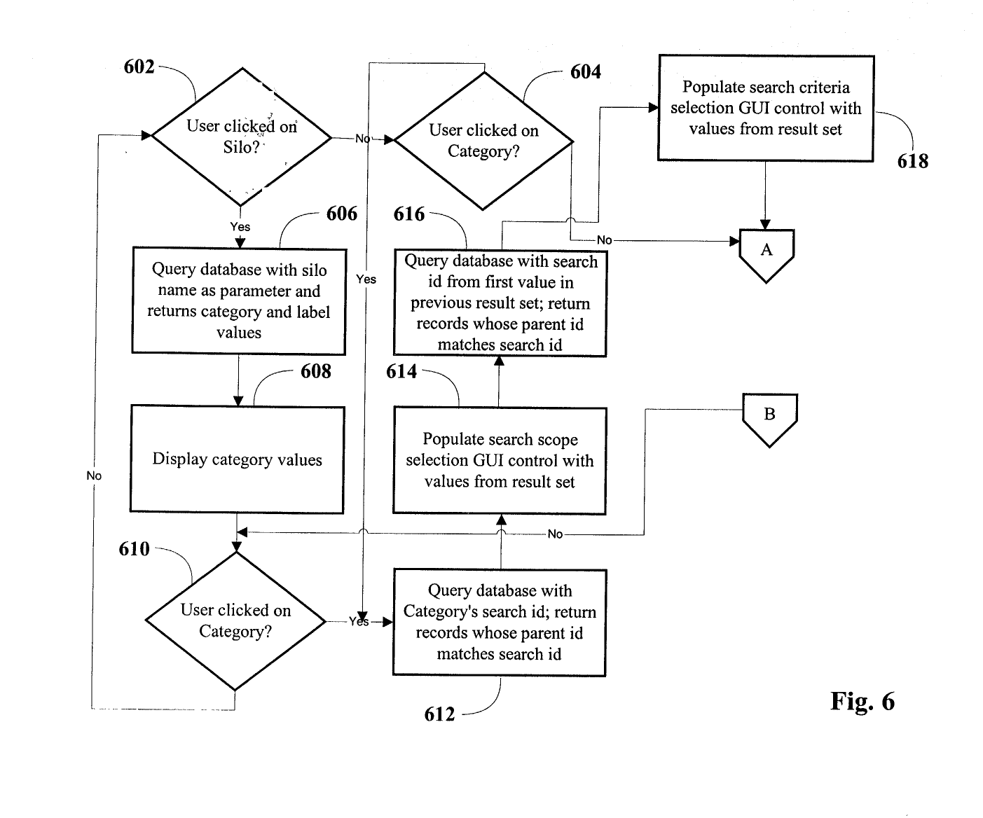

FIG. 6 presents a flow diagram presenting a method of populating the search controls with parameters or values that are relevant to the particular silo, category, or subcategory selected by the user according to information stored in the session object or database. The flow diagram starts by determining whether the user selected a silo, step 602. If the user has selected a silo, the system will query the database with the silo name as a parameter and return the category values and search bar labels, step 606. Once the result set is returned, the system will display the category values, step 608. If the user selects one of the displayed categories, step 610, e.g., navigates to the category, the database will be queried with the category's search id and return records whose parent id matches the category's search id, step 612. This data will be used to populate the graphical control of the search bar that sets the query's scope, step 614. The first value from this result set will be used as a parameter for a second query that will return all records whose parent id matches the supplied search id, step 616, this result set contains the set of criteria associated with the displayed scope value, e.g., the first value in the scope query's result set. This data is then used to populate the criteria selection GUI control, step 618.

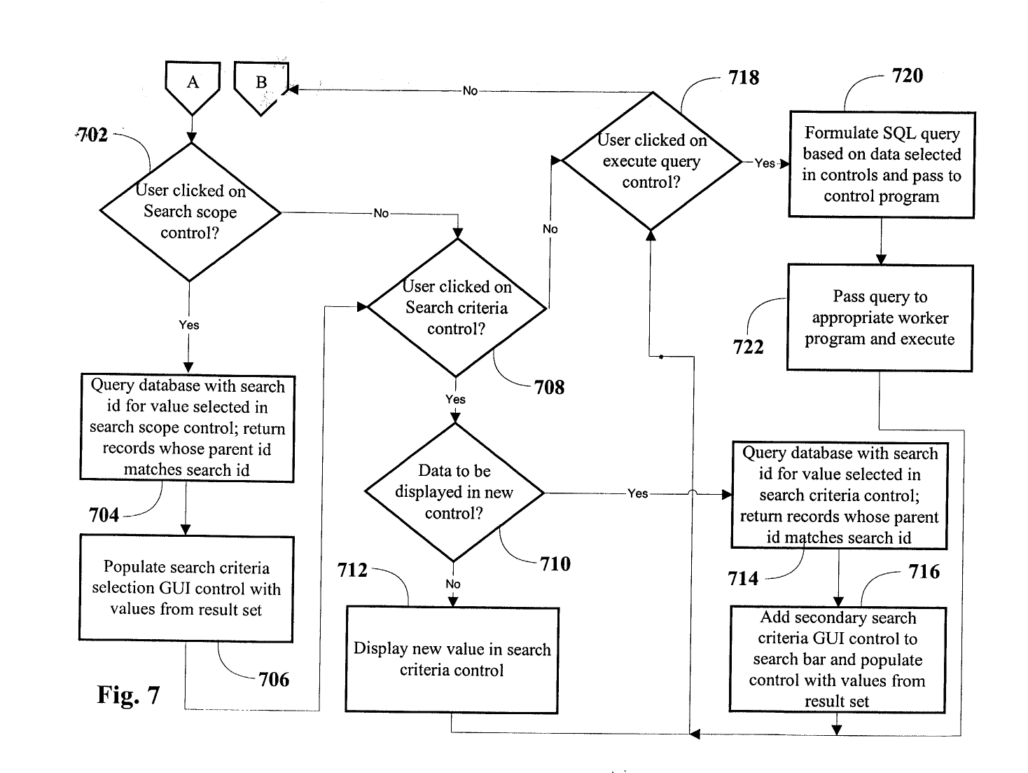

The process presented in FIG. 6 continues with the flow diagram of FIG. 7. When the user selects the search scope GUI control and sets it to a new value, step 702, the criteria GUI control is updated to provide criteria values that are relevant to the selected scope value. The database is queried with the search id for the value selected in the search scope control and records are returned whose parent id matches the search id, step 704. The criteria selection GUI control is populated with values from the result set, step 706. When the user selects the search criteria GUI control and sets it to a new value, step 708, a check is made to determine if the criteria selected is further associated with criteria data that must be displayed in an additional search criteria GUI control, step 710. Where there is no associated data, the new value is displayed in the search criteria GUI control, step 712. Where associated data is present, the database is queried with the search id for the value selected in the search criteria GUI control and records are returned whose parent id matches the search id, step 714.

A secondary search criteria GUI control is dynamically added to the search bar and populated with values from the result set, step 716. In this manner, the search bar dynamically reconfigures itself depending on the actions of the user. If the user selects the execute query control, step 718, the parameters from the search scope, criteria, any secondary search criteria and any values from text entry boxes are formatted into a SQL query and passed to the control program, step 720. The control program passes the request or requests to the appropriate worker program or programs designed to query one ore more data repositories, step 722, which may be, but is not limited to, SQL databases. If the user has not selected to execute a query, step 718, programmatic flow returns to step 610 until the appropriate user interaction is intercepted.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth. Above as such variations and modification are intended to be included within the scope of the invention.

We claim:

1. A method for providing context sensitive query parameters, the method comprising:
determining a first location of a user within an information system;
querying a data structure, the data structure storing one or more query parameters each associated with a location in the information system, with a query comprising a first identifier indicating the first location of the user within the information system, the query operative to return one or more first query parameters associated with the first identifier; and
transmitting the first query parameters to the user.

2. The method of claim 1 wherein the data structure used in querying comprises a database.

3. The method of claim 2 wherein the database is a relational database.

4. The method of claim 2 wherein the database is an object-oriented database.

5. The method of claim 1 comprising:
determining a second location of the user within the information system;
querying the data structure, the data structure storing one or more query parameters each associated with a location in the information system, with a query comprising a second identifier indicating the second location of the user within the information system, the query operative to return one or more second query parameters associated with the second identifier; and
transmitting the second query parameters to the user.

6. The method of claim 5 comprising returning query labels associated with the first or second query parameters.

7. The method of claim 6 comprising displaying the query labels in proximity to the associated query parameter.

8. The method of claim 5 wherein the step of displaying comprises displaying the query parameters using GUI controls.

9. The method of claim 8 wherein the GUI control is a drop list.

10. The method of claim 8 comprising:
querying the data structure by providing the first or second identifier indicating the first or second location of the user within the information system;
generating one or more GUI controls, the number and type of GUI controls generated being determined by the first or second identifier indicating the first or second location of the user within the information system; and
transmitting the GUI controls to the user.

11. The method of claim 6 comprising:
selecting the desired query parameters displayed on a display device to construct a query; and
querying the data structure using the query constructed in the selecting step, the query operative to return a result set comprised of data stored in the data structure that falls within the scope defined by the query; and
displaying the result set on the display device for presentation to the user.

12. Computer readable media containing program code, the program code operative to instruct a programmable processor to execute a method for providing context sensitive query, the method comprising:
determining a first location of a user within an information system;
querying a data structure, the data structure storing one or more query parameters each associated with a location in the information system, with a query comprising a first identifier indicating the first location of the user within the information system, the query operative to return one or more first query parameters associated with the first identifier; and
transmitting the first query parameters to the user.

13. The method of claim 12 wherein the data structure used in querying comprises a database.

14. The method of claim 13 wherein the database is a relational database.

15. The method of claim 13 wherein the database is an object-oriented database.

16. The method of claim 12 comprising:
determining a second location of the user within the information system;
querying a data structure, the data structure storing one or more query parameters each associated with a location in the information system, with a query comprising a second identifier indicating the second location of the user within the information system, the query operative to return one or more second query parameters associated with the second identifier; and
transmitting the second query parameters to the user.

17. The method of claim 16 comprising returning query labels associated with the first or second query parameters.

18. The method of claim 17 comprising displaying the query labels in proximity to the associated query parameter.

19. The method of claim 16 wherein the step of displaying comprises displaying the query parameters using GUI controls.

20. The method of claim 19 wherein the GUI control is a drop list.

21. The method of claim 19 comprising:
querying the data structure by providing the first or second identifier indicating the first or second location of the user within the information system;
generating one or more GUI controls, the number of GU controls generated being determined by the first or second identifier indicating the first or second location of the user within the information system; and
transmitting the GUI controls to the user.

22. The method of claim 17 comprising:
selecting the desired query parameters displayed on a display device to construct a query;
querying the data structure using the query constructed in the selecting step, the query operative to return a result set comprised of data stored in the data structure that falls within the query scope; and
displaying the result set on the display device for presentation to the user.
